(19) United States
(12) Patent Application Publication
(10) Pub. No.: US 2025/0172333 A1
(43) Pub. Date: May 29, 2025

(54) INSULATION SYSTEM UTILIZING PHASE CHANGE MATERIAL

(71) Applicant: BMIL TECHNOLOGIES, LLC, Morehead City, NC (US)

(72) Inventor: Thomas J. BACKMAN, Morehead City, NC (US)

(73) Assignee: BMIL TECHNOLOGIES, LLC, Morehead City, NC (US)

(21) Appl. No.: 18/963,269

(22) Filed: Nov. 27, 2024

Related U.S. Application Data
(60) Provisional application No. 63/603,063, filed on Nov. 27, 2023.

(51) Int. Cl. F25D 23/06

(52) U.S. Cl. CPC F25D 23/065; F25D 2201/00

(57) ABSTRACT

An insulation system for a refrigerated room or container. The insulation system includes a plurality of panels each panel having an outer side and an inner side surrounding an inner volume. There are PCM tanks disposed within the panels on the inner side, and the PCM tanks are surrounded by a thermally insulating rigid foam substrate and filled with phase change materials. The rigid foam contacts both the inner and outer side of the panels and is a structural member configured to support the PCM tanks to contact the inner side of the insulated panels.

### BACKGROUND

Cold rooms, or cooler, or freezers, are typically described as rooms colder than 65 F (18.3 C). The products stored in cold rooms tend to endure damage, spoilage, or destruction when the room temperature rises above the storage specification for the products. In order to protect the cold products in cold rooms, there have been developed phase change material (PCM) tanks or containers that will store heat absorption capacity in the latent heat of fusion of a phase change material. These tanks are generally attached to the ceilings, or the shelving in the cold room. When there is an outage of the refrigeration system, causing cooling to cease, the PCM in the tanks within the room will change state from solid to liquid, absorbing heat from the cold room, allow for passive cooling during the outage. One issue with the tanks in the room is that they have crevices that are difficult to clean and sanitize. Additionally, these tanks are occasionally submitted to damage and subsequently a release of the PCM material from the tank.

Building materials have been developed with PCM blended into the material that the walls and ceilings are made of. For example, the wall may be made of paraffin PCM blended into gypsum. This material is evenly blended from the cold side to the warm side of the wall. When these materials are utilized in cold rooms, the passive cooling effectiveness of the material at the cold side of the wall is high because the heat transfers quickly. The passive cooling just a fraction of an inch inside of the wall is less effective because the PCM is insulated from the cold room. Due to the insulation between the cold room and the PCM beyond halfway through the wall, the passive cooling is negligible. In other words, the PCM at the cold side of the wall transfers heat readily, but the PCM past the cold side of the wall cannot absorb heat fast enough to prevent product losses in the cold room during an outage. The means that only the PCM at the cold side of the wall is effective.

Most cold rooms, coolers, and freezers are constructed of insulated metal panels with foam insulation between two metal skins. These insulated metal panels are often made of polyurethane, polyisocyanurate, or polystyrene foam. The insulation can be injected between metal sheets such that it will expand and bond to the metal sheets. The insulation can be made in foam sheets that are then bonded to metal sheets with adhesives.

In this invention, the PCM is injected into perforated tanks. The perforated tanks are embedded into the polyurethane, polyisocyanurate, or polystyrene foam and against the metal sheet that is the surface of the cold side of the wall. The perforations in the tank allow the polyurethane, polyisocyanurate, or polystyrene foam to be bonded to the metal sheet that is the surface of the cold side of the wall. This allows the foam that is attached to the metal sheet that is the surface of the cold side of the wall to securely and permanently hold the PCM tank in place.

### BRIEF DESCRIPTION OF THE DRAWINGS

The features, aspects, and advantages of the disclosed deliver system will become apparent from the following description, and the accompanying exemplary embodiments shown in the drawings, which are briefly described below.

FIG. 1 is a simplified diagram of a perforated PCM tank.

FIG. 2A is an exemplary insulation system showing a simplified diagram of a perforated PCM tanks inside the foam and against the metal skin.

FIG. 2B is a section view A-A of the insulation system as shown in FIG. 2A.

FIG. 3 is an exemplary insulation system showing a simplified diagram of a perforated PCM tanks inside the foam walls, ceiling, and floor, mounted against metal sheets on the cold side of the panel.

### DESCRIPTION

An insulation system for a refrigerated room or container is disclosed herein. The insulation system comprising panels having an outer side and an inner side surrounding an inner volume. PCM tanks or containers are disposed within the panels on the inner side, and the PCM tanks are surrounded by a thermally insulating rigid foam substrate and filled with phase change materials. The rigid foam contacts both the inner and outer side of the panels and is a structural member configured to support the PCM tanks to contact the inner side of the insulated panels.

In an exemplary embodiment, an insulation system is disclosed including a phase change material (PCM) stored in tanks that are built into walls, ceiling, and floors of a refrigerator/freezer.

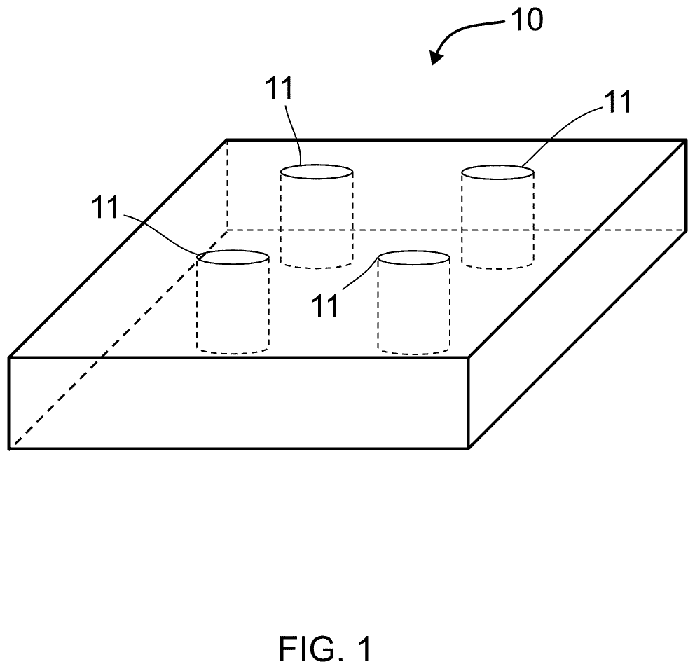

Referring to FIG. 1, a PCM tank 10 is shown having perforations 11. Each perforation 11 is a channel that extends from one side of the PCM tank 10 to another opposing side. The number of perforations may vary depending on cooling and structural needs of the refrigeration system.

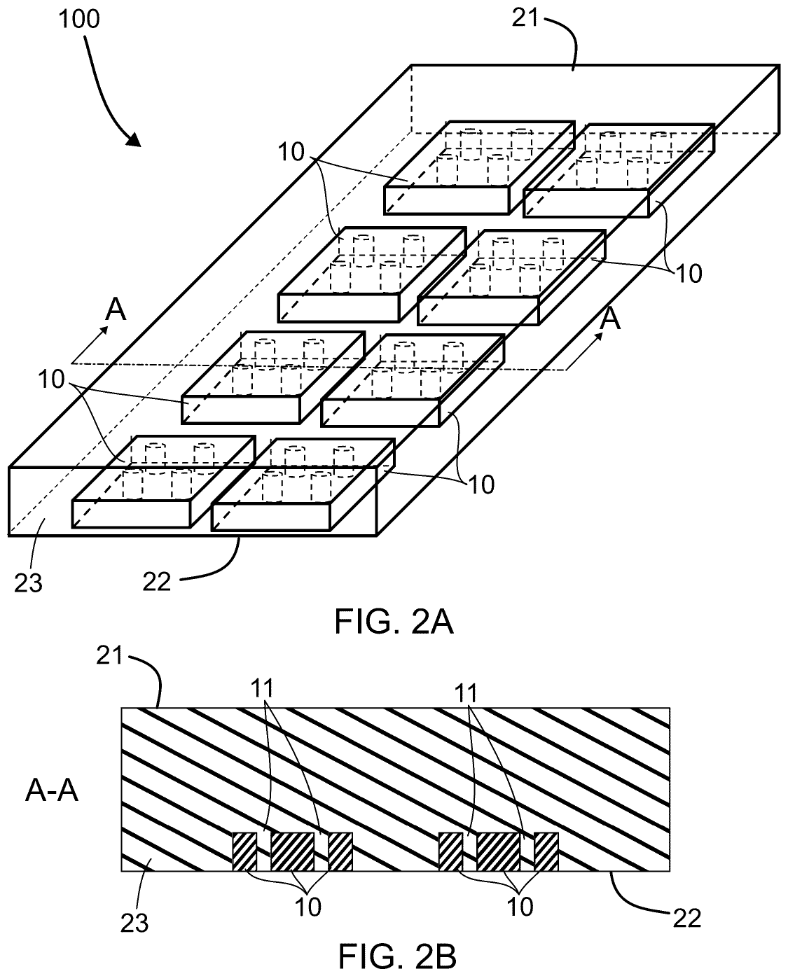

Referring to FIG. 2A, an insulation system 100 is shown comprising a set of PCM tanks 10 each having perforations 11 disposed within a wall 20 having an outer side 21 and an inner side 22. The PCM tanks 10 are disposed on an inner side 22 (i.e., cold side) of wall 20. The remaining volume of the wall 20 contains foam 23 that extend from the outer side 21 to the inner side 22 and along the length of the wall. Perforations 11 of the PCM tanks allow the foam 23 to extend through the PCM tank 10 and adhere to the inner side 22. Foam 23 (and its substitutes) are configured to reduce heat transfer from the outside (e.g. via the outer side 21). In some embodiments, foam 23 may be made of polyurethane, polyisocyanurate, or polystyrene foam. In some embodiments, foam 23 may be substituted with wool substrate.

Referring to FIG. 2B, this view shows the section A-A as noted in FIG. 2A. The foam 23 extends from the outer side 21 and inner side 21. The perforations 11 allow the foam to extend through the PCM tank 10 and adhere to the inner side 22.

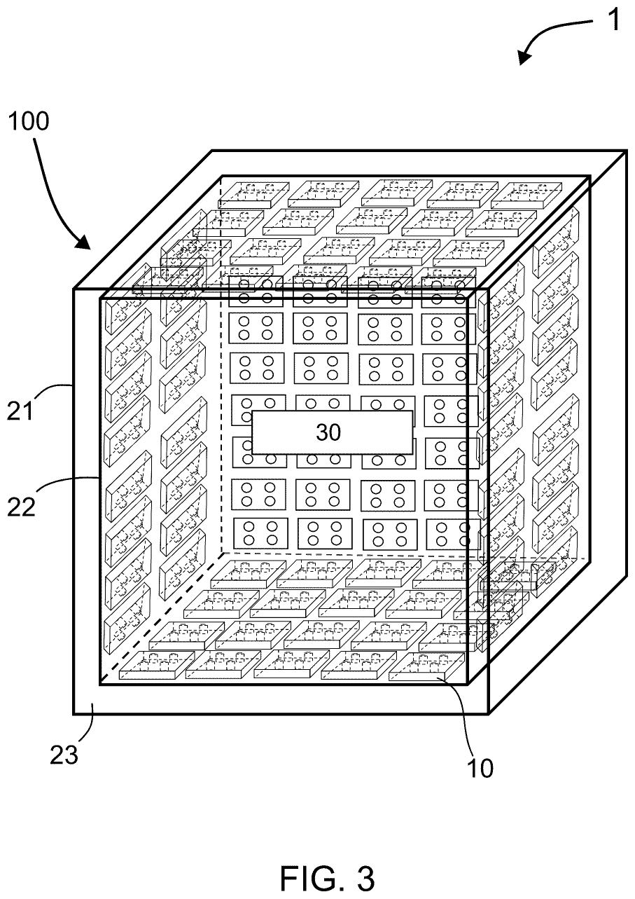

FIG. 3 is an exemplary embodiment of a refrigeration system 1 utilizing the insulation system 100. The refrigeration system 1 shown may include four identical sides (one side omitted for clarity). The omitted side may include a door that comprises one or more PCM tank(s) for entry/exit of the refrigeration system 1. The inner volume 30 may be a temperature-controlled volume that is configured to be temperature controlled. The temperature-controlled volume may be a cold volume. The temperature controlled volume may be part of a refrigerated volume of a refrigeration system containing goods that is required to be held below a certain temperature to prevent spoiling or deterioration.

The following is a detailed explanation of the invention. For example, a walk-in freezer with a size of 10 ft.×10 ft.×10 ft with each of the walls being 4″ thick (including the ceilings and floors) may have a closed-door cooling load of 2,186 btu/hr at −10° F. In this embodiment, the room could call for a phase change material (PCM) that has a heat of fusion of 100 btu per pound at −9° F. This PCM could be injected into perforated PCM tanks (i.e. PCM tanks 10) that hold 0.5 pounds each of PCM per square foot, for a latent heat storage of 50 btu per square foot inside the insulated metal panels. During operation, the PCM may be frozen due to the close proximity to the metal skins on the cold side of the insulated metal panels. In this exemplary embodiment, the interior of the freezer is made of six 10×10 sections of insulated metal panels, for 600 square feet of interior surface. At 50 btu per square foot, the insulated metal panels that make up the freezer have a latent heat of fusion storage of 50×600=30,000 btu/hr. As stated before, the cooling requirement for this −10° F. freezer to maintain temperature is 2,186 btu/hr. The thermal storage inside the PCM stored in tanks that are built into the 4″ thick walls allow for 13.72 hours of outage (30,000÷2,186=13.72). That is to say that the tanks of PCM that are attached to the metal skins that make up the interior of the refrigeration system will avoid product loss for 13.72 hours when a power outage occurs. The amount of PCM tanks can be selected based on the required or designed duration for maintaining safe temperature ranges for products within the refrigeration system during a power outage.

In one embodiment, insulated metal panels manufactured with PCM tanks within a foam substrate and filled with phase change materials such that the tanks located near to the metal sheets that create cold side of the walls, ceilings, and floors for cold rooms that are assembled in the field. The foam surrounding the tanks is rigid, which allows the foam to support the weight of the PCM tanks.

In one embodiment, the PCM tanks inside the foam substrate are attached to the metal sheets that create cold side of the walls, ceilings, and floors for cold rooms that are assembled in the field.

In one embodiment, insulated metal panels as mentioned above may be configured for a walk-in freezer application with PCM materials engineered to thaw at designated temperatures ranging from −58° F. to +32° F.

In one embodiment, insulated metal panels may be configured for a walk-in cooler application with PCM materials engineered to thaw at designated temperatures ranging from +32° F. to +65° F.

In one embodiment, the PCM tanks are made of metal such as steel, aluminum, copper, stainless steel, or brass.

In one embodiment, the PCM tanks are made of rigid plastics or polymers.

In one embodiment, PCM tanks are made of plastic or polymer film.

In one embodiment, the PCM tanks have perforations in them to allow the foam to bridge from the back of the tank through to the metal sheet and adhere to the metal sheet.

In one embodiment, the panel foam insulation is polyurethane poured in place to form around the PCM tank during expansion, securing the tank in place near the metal sheet that is exposed to the cold side of the wall, ceiling, or floor panel. The foam insulation insulates the PCM tank to reduce heat transfer from the PCM to the warm side of the wall, ceiling, or floor panel.

In one embodiment, the panel foam insulation is polyisocyanurate poured in place to form around the PCM tank during expansion, securing the tank in place near the metal sheet that is exposed to the cold side of the wall, ceiling, or floor panel. The foam insulation insulates the PCM tank to reduce heat transfer from the PCM to the warm side of the wall, ceiling, or floor panel.

In one embodiment, the panel foam insulation is expanded polystyrene machined to form around the PCM tank, securing the tank in place near the metal sheet that is exposed to the cold side of the wall, ceiling, or floor panel. The foam insulation insulates the PCM tank to reduce heat transfer from the PCM to the warm side of the wall, ceiling, or floor panel.

In one embodiment, the panel foam insulation is molded polystyrene machined or molded to form around the PCM tank, securing the tank in place near the metal sheet that is exposed to the cold side of the wall, ceiling, or floor panel. The foam insulation insulates the PCM tank to reduce heat transfer from the PCM to the warm side of the wall, ceiling, or floor panel.

In one embodiment, the insulated metal panels manufactured with PCM tanks within a mineral wool substrate and filled with phase change materials such that the tanks located near to the metal sheets that create cold side of the walls, ceilings, and floors for cold rooms that are assembled in the field. The mineral wool surrounding the tanks is rigid, which allows the mineral wool to support the weight of the PCM tanks.

In one embodiment, the panel insulation is mineral wool machined to form around the PCM tank, securing the tank in place near the metal sheet that is exposed to the cold side of the wall, ceiling, or floor panel. The mineral wool insulation insulates the PCM tank to reduce heat transfer from the PCM to the warm side of the wall, ceiling, or floor panel.

What is claimed:

1. An insulation system for a refrigerated room or container comprising:
a plurality of panels each panel having an outer side and an inner side surrounding an inner volume;
PCM tanks disposed within the panels on the inner side, wherein the PCM tanks are surrounded by a thermally insulating rigid foam substrate and filled with phase change materials;
wherein the rigid foam contacts both the inner and outer side of the panels and is a structural member configured to support the PCM tanks to contact the inner side of the insulated panels.

2. The insulation system of claim 1, wherein the PCM tanks are attached to the inner side of panels that create a cold side of the walls, ceilings, and floors for a cold room defined by the inner volume.

3. The insulation system of claim 1, wherein the PCM tanks contain PCM configured to thaw at designated temperatures ranging from −58° F. to +32° F.

4. The insulation system of claim 1, wherein the PCM tanks contain PCM configured to thaw at designated temperatures ranging from +32° F. to +65° F.

5. The insulation system of claim 1, wherein the PCM tanks are made of metal such as steel, aluminum, copper, stainless steel, or brass.

6. The insulation system of claim 1, wherein the PCM tanks are made of rigid plastics or polymers.

7. The insulation system of claim 1, wherein the PCM tanks are made of plastic or polymer film.

8. The insulation system of claim 1, wherein the PCM tanks have perforations in them to allow the foam to bridge from the back of the tank through to the metal sheet and adhere to the inner side of the panels.

9. The insulation system of claim 1, wherein the rigid foam is polyurethane formed around the PCM tank during expansion, wherein the PCM tank is secured in place on the inner side that is adjacent to the cold side of the wall, ceiling, or floor panel, wherein the rigid foam is configured to insulate the PCM tank to reduce heat transfer of the PCM tank to the outer side of the panel, ceiling, or floor panel.

10. The insulation system of claim 1, wherein the rigid foam is polyisocyanurate formed around the PCM tank during expansion, wherein the PCM tank is secured in place on the inner side that is adjacent to the cold side of the wall, ceiling, or floor panel, wherein the rigid foam is configured to insulate the PCM tank to reduce heat transfer of the PCM tank to the outer side of the panel, ceiling, or floor panel.

11. The insulation system of claim 1, wherein the rigid foam is expanded polystyrene formed around the PCM tank during expansion, wherein the PCM tank is secured in place on the inner side that is adjacent to the cold side of the wall, ceiling, or floor panel, wherein the rigid foam is configured to insulate the PCM tank to reduce heat transfer of the PCM tank to the outer side of the panel, ceiling, or floor panel.

12. The insulation system of claim 1, wherein the rigid foam is molded polystyrene formed around the PCM tank during expansion, wherein the PCM tank is secured in place on the inner side that is adjacent to the cold side of the wall, ceiling, or floor panel, wherein the rigid foam is configured to insulate the PCM tank to reduce heat transfer of the PCM tank to the outer side of the panel, ceiling, or floor panel.

13. The insulation system of claim 1, wherein the rigid foam is mineral wool substrate formed around the PCM tank during expansion, wherein the PCM tank is secured in place on the inner side that is adjacent to the cold side of the wall, ceiling, or floor panel, wherein the rigid foam is configured to insulate the PCM tank to reduce heat transfer of the PCM tank to the outer side of the panel, ceiling, or floor panel.

14. The insulation system of claim 1, wherein the rigid foam is machined wool formed around the PCM tank during expansion, wherein the PCM tank is secured in place on the inner side that is adjacent to the cold side of the wall, ceiling, or floor panel, wherein the rigid foam is configured to insulate the PCM tank to reduce heat transfer of the PCM tank to the outer side of the panel, ceiling, or floor panel.
